(19) United States
(12) Patent Application Publication
(10) Pub. No.: US 2019/0210020 A1
(43) Pub. Date: Jul. 11, 2019

(54) HIGH DENSITY NANOFLUIDICS

(71) Applicant: Genturi, Inc., Woburn, MA (US)

(72) Inventors: Jeff KROGMEIER, Winchester, MA (US); Hardeep SINGH, Arlington, MA (US); Robert DUBROW, San Carlos, CA (US); Laurent MENARD, Raleigh, NC (US); Andrew GOLDEN, Boston, MA (US); Samrudhi SHARMA, Billerica, MA (US)

(21) Appl. No.: 16/238,873

(22) Filed: Jan. 3, 2019

Related U.S. Application Data
(60) Provisional application No. 62/643,234, filed on Mar. 15, 2018.
(60) Provisional application No. 62/613,968, filed on Jan. 5, 2018.

(51) Int. Cl. B01L 3/00

(52) U.S. Cl. CPC B01L 3/502715; B01L 3/502707; B01L 2300/0848; B01L 2300/0896; B01L 2300/123

(57) ABSTRACT

Nanofluidic chips are described herein that are configured for high-volume manufacturing and maintaining sample integrity in multiplexed devices comprising: at least two devices, wherein each device comprises at least one sample inlet and at least one nanochannel; and a detection region, wherein the at least two devices pass through the detection region and wherein the at least two devices are fluidically distinct from the inlet through the detection region, and wherein actuation energy can be applied independently to at least two devices.

### CROSS-REFERENCE TO RELATED APPLICATIONS

This application claims the benefit of priority of US Provisional Application Nos. 62/613,968, filed Jan. 5, 2018, and 62/643,234, filed Mar. 15, 2018, the contents of all of which are incorporated by reference herein in their entirety for any purpose.

### FIELD

High density nanofluidic chips for nanofluidic detection assays

### BACKGROUND

Nanofluidic chips are used for a variety of lab-on-a-chip assays in the biotechnology field. There is commercial pressure to lower the cost per sample tested. This can often be achieved if nanofluidic chips can accommodate more samples in a given chip footprint, because the chip manufacturing costs are roughly constant regardless.

There is a need for high-density nanofluidic chips, or chips comprising multiple experimental devices (i.e., parallelization), in order to introduce efficiencies in workflow, assay run time and/or assay cost. Such efficiencies are valuable to customers of both research tools products and diagnostics.

However, design and manufacturing challenges of high-density nanofluidic chips may arise in practice because it is difficult to manufacture devices with the required precision. Nanofluidic chip mass production for research tools and/or diagnostics, in particular, faces an emerging need for both high-density nanofluidic chips, but these devices have faced design and manufacturing/process challenges.

These design challenge difficulties arise due to addition of necessary features in a small footprint. First, fluidic vias (i.e., inlets) may occupy a large percentage of a chip surface area (e.g., to satisfy customer usability requirements), reducing the number of fluidic vias that can be placed on a chip. For some applications, end users may desire to use wide-bore pipette tips to transfer DNA in order to minimize shear-based damage; these wide-bore pipette tips may require even larger fluidic vias, increasing the design challenge. Second, cost, quality, and time-to-market concerns may drive fluidics to a single layer in some designs. Third, nanofluidic designs may have a pair of microfluidic legs on each side of the nanofluidics, in order to minimize clogging during chip prep. Such a configuration may double the number of fluidic pathways on a chip. A typical mitigation approach has been to employ a common detection device for distinct samples or data points (e.g., Bioanalyzer), but this approach introduces the risk of cross-contamination, which could compromise data quality. Therefore, one aspect of the present improved devices is to meet design requirements in a parallelized nanofluidic chip, but without compromised performance. Fourth, there may be a need to minimize autofluorescence of optical assays by reducing chip background, so there is a need to make chips thinner at the optical region without reducing overall dimensional stability.

Manufacturing challenges arise, in part, because nanofluidic chip mass production generally requires tighter manufacturing process controls than microfluidic, millifluidic, or macrofluidic chip mass production. Manufacturing processes that require tighter process controls may include one or more of: etching, mastering, master conversion, injection molding, hot embossing, bonding and other manufacturing processes as is known in the art of chip production in any of a variety of known materials. Moreover, ability to detect failed parts is more challenging and costly as the size scale shrinks to the nanoscale. Therefore, another aspect of the present improved devices is to address the need for robust and cheap manufacturing processes for nanofluidic high density chips.

In particular, this application describes systems, designs and methods to focus nanofluidic components from individually addressable devices into a single portion of a high-density chip. A unidirectional valving system allows nanofluidic components to employ a common outlet without cross-contamination, simplifying the number of fluidic channels required to supply the parallel devices.

### SUMMARY

In accordance with the description, a nanofluidic chip configured for high-volume manufacturing and maintaining sample integrity in multiplexed devices comprises: (a) at least two devices, wherein each device comprises (i) at least one sample inlet and (ii) at least one nanochannel; and (b) a detection region, wherein the at least two devices pass through the detection region and wherein the at least two devices are fluidically distinct from the inlet through the detection region, and wherein actuation energy can be applied independently to at least two devices.

In one embodiment, a method of producing any of the nanofluidic chips described herein comprises producing a plastic nanofluidic chip using injection molding and fabricating the nanochannels with focused ion beam (FIB) milling.

In another embodiment, a method of analyzing at least one biological sample in fluid form on the nanofluidic chip comprises loading a biological sample onto one or more devices using a sample inlet, flowing the biological sample through the nanochannel, and conducting a detection step.

Additional advantages will be set forth in part in the description which follows, and in part will be obvious from the description, or may be learned by practice. The advantages will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate one (several) embodiment(s) and together with the description, serve to explain the principles described herein.

### BRIEF DESCRIPTION OF THE DRAWINGS

FIG. 1 shows a top planar view of an embodiment of a nanofluidic chip that has 4 devices, each with 1 inlet sample via, 1 inlet sink via, and 2 outlet vias.

FIG. 2A is an exploded view of a portion (Box I) of the chip of FIG. 1.

FIG. 2B is an exploded view of a portion (Box II) of FIG. 2A.

FIG. 3 is an exploded view of a portion (Box III) of FIG. 2B.

FIG. 4 shows a top planar view of another embodiment of a nanofluidic chip that has 16 devices, with 16 inlet sample via, 4 inlet sink vias and 2 outlet vias with a common outlet trough.

FIG. 5A is an exploded view of a portion (Box I) of the chip of FIG. 4.

FIG. 5B is an exploded view of a portion (Box II) of FIG. 5A.

FIG. 6 is an exploded view of a portion (Box III) of FIG. 5B.

FIG. 7 is an exploded view of a top portion of FIG. 6.

FIG. 8A shows a layered structure of an embodiment of an assembled nanofluidic chip.

FIG. 8B shows a bottom view of the assembled nanofluidic chip of FIG. 8A.

FIG. 9A is a top planar view of the assembled nanofluidic chip of FIG. 8A.

FIG. 9B is a bottom planar view of the assembled nanofluidic chip of FIG. 8A.

FIG. 10 is a side view of the assembled nanofluidic chip of FIG. 8A.

FIG. 11 shows a top planar view of another embodiment of a nanofluidic chip that has 20 vias, with 16 inlet sample vias, 2 outlet vias, and 2 inlet sink vias.

FIG. 12 shows a top planar view of another embodiment of a nanofluidic chip that has 20 vias, with 16 inlet sample vias, 2 outlet vias, and 2 inlet sink vias.

FIG. 13A is a top side view of an embodiment of a frame in which multiple chips are assembled.

FIG. 13B is a bottom side view of the frame as in FIG. 13A.

FIG. 14 is a cross section view of a nanofluidic channel having a tapered profile constituting a draft angle.

FIG. 15 is a cross section view of the chip of FIG. 8A showing a reservoir.

### DESCRIPTION OF THE EMBODIMENTS

### I. Definitions

By “analyte,” we mean any species to be detected. This may include, but is not limited to, nucleic acids (including DNA, RNA, and others), polymer, beads, biologics attached to beads, molecule capable of optical or electrical detection, molecule capable of binding to detectable molecules for optical or electrical detection, protein, cell, etc.

By “chip,” we mean an apparatus in planar form that can perform operations or assays on molecules. A chip may comprise one or more devices. A chip may be a fluidic chip or it may be a nanofluidic chip.

By “device,” we mean a component of a chip that can accommodate a sample and interface with an instrument, which, together, provide an experimental result for the sample. The device may include an inlet, an outlet, a detection region (e.g., nanochannels), and a means for interfacing with the detection system. The device may optionally include a fluid transport region or regions, which may also be nanochannels. In some embodiments, a device is fluidically distinct from other devices on the same chip from the inlet to the detection region.

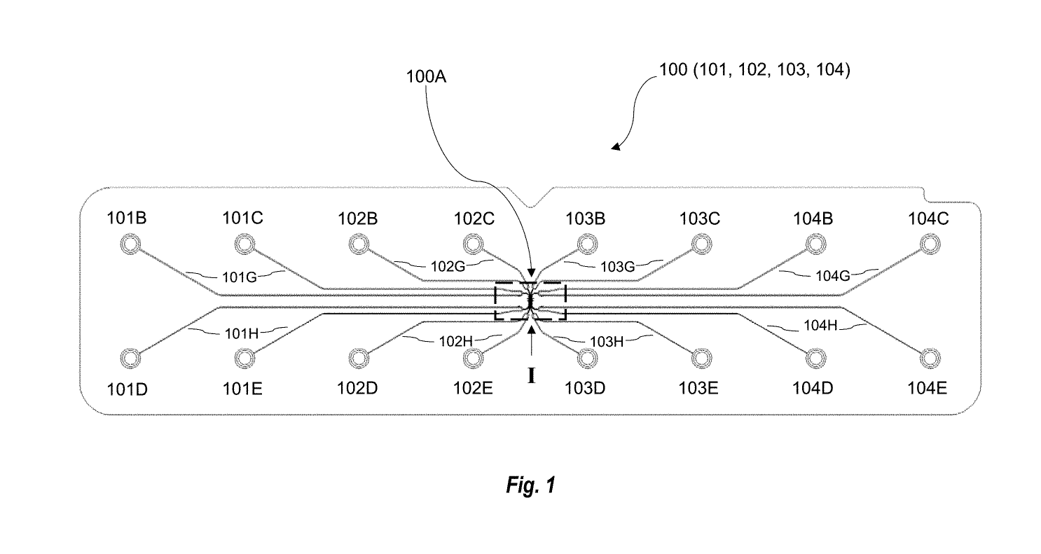

By “detection region,” we mean a region of a chip in which detection occurs. In some embodiments, a large number of nanochannels from fluidically distinct devices may be routed through the detection region. The nanochannels may all be from different devices, or groups may correspond to particular devices (e.g., 4 nanochannels per device, 16 devices per detection region). From a top planar view (as in FIGS. 1-3), a detection region has an area defined by a width (a dimension across nanochannels) and a length (a dimension along nanochannels).

By “detection system,” we mean any apparatus or system of apparatus capable of detecting an analyte by any means known in the art, including, but not limited to, optical methods (e.g., transparent window through which light from a radiation source (laser, mercury arc lamp, light emitting diode, etc.), transmitted light, fluorescence, luminescence, phosphorescence, etc. can pass; optics for directing incident, transmitted, and/or emitted light such as optical lens, mirrors, gratings prisms, and monochromators for colorimetric analysis; and detectors such as a camera, APD (avalanche photo diode) detector, and a PMT (photomultiplier tube) detector) and electrical methods (e.g., electrical contacts (such as electrodes or electrical sensors) and circuits for detecting a voltage change, current change, conductivity change, capacitive change, etc. due to the presence of analyte(s)).

By “fluidic channel,” we mean an enclosed channel (or substantially enclosed channel) capable of carrying a fluid, with a length and cross-section. The cross-sectional shape may be round, oval, parallelogram-shaped, rectangular, square, etc.

By “fluidically distinct,” we mean fluidic channels that do not connect or exchange/share liquids for at least a portion of the length, although they may be positioned or routed adjacently. In some embodiments, fluidically distinct channels do not connect or exchange/share liquids for only part of their length, while in other embodiments fluidically distinct channels do not connect or exchange/share liquids for all of their length.

By “inlet,” we mean a structure or structures upstream of the detection region for loading and transport of a sample before the detection step. An inlet may comprise an inlet sample via, an inlet sink, and various fluidic components.

By “inlet sample via” we mean a via on the inlet side of the device for accepting a sample for loading onto the device. An inlet sample via is designed to not be shared between devices.

By “inlet sink,” we mean a via on the inlet side of the device that functions in priming the device, but which is not designed for loading sample onto the device. An inlet sink may be shared between devices as sample flows from the channels into the inlet sink and not out of the inlet sink into the channels, thus avoiding intersample contamination.

By “instrument,” we mean machinery that integrates with a chip (and/or device), customer and software. The instrument may comprise user inputs, detection capability, and reporting capability.

By “macrochannel,” we mean a fluidic channel with the smallest dimension—whether cross-sectional width, depth, wall-to-wall distance, and/or diameter—that is at least 10 mm, for at least a portion of the length of the channel.

By “millichannel,” we mean a fluidic channel with the smallest dimension—whether cross-sectional width, depth, wall-to-wall distance, and/or diameter—that is at least 1 mm, but less than 10 mm, for at least a portion of the length of the channel.

By “microchannel,” we mean a fluidic channel with the smallest dimension—whether cross-sectional width, depth, wall-to-wall distance, and/or diameter—that is at least 1 μm to less than 1000 μm (or 1 mm), for at least a portion of the length of the channel.

By “nanochannel,” we mean a fluidic channel with cross-sectional width, depth, wall to wall distance, and/or diameter that is <1 micrometer, for at least a portion of the length of the channel. The prefix nano (as in nanofluidic, etc.) also imparts the same meaning. For example, in some embodiments, a nanochannel may be 0.999, 0.99, 0.95, or 0.9 micrometer for at least a portion of the length of the channel.

By “nanofluidic chip,” we mean an apparatus in planar form having at least one nanochannel that can perform operations or assays on molecules. A nanofluidic chip may comprise one or more devices.

By “outlet,” we mean a structure or structures downstream of the detection region that accommodates waste after the detection step. The outlet may comprise an outlet via or it may comprise a fluid reservoir that may optionally have an air vent or may be of a size to accommodate fluid without an air vent. In some embodiments, the outlet comprises an outlet trough.

By “outlet trough,” we mean a component of an outlet that serves as an outlet for a series of nanochannels that lead into it. In some embodiments, the outlet trough comprises a nanoscale orifice between the outlet trough and the nanochannels.

By “multiplexing” or “parallelization,” we mean multiple devices on one chip, where each device provides the opportunity to assay a different sample from one or more other devices on the chip.

By “routing,” we mean positional layout of the fluidic channels with respect to geometry of the chip.

By “sample” we mean a sample, such as, but not limited to a biological sample, for detection of a single analyte or multiple analytes. The multiple analytes may overlap in size distribution or not. The analyte(s) may be a species of interest (e.g., DNA to be sequenced) and/or an interferent (e.g., contaminant). The analyte(s), including a species of interest, interferent, or contaminant, may be present in a solution.

By “via” we mean an interface between inside the chip and the outer environment. Vias are also known as ports or wells. Vias are used for adding or removing fluid from the devices on the chip.

By “entropic barrier” (or “entropic trap”) we mean an element that prevents analyte(s) or interferents from flowing backward through a nanochannel due to entropic effects (i.e., there is an energy barrier due to a decrease in available molecular conformations of an analyte or interferent in the nanochannel, the energy barrier being on the order of thermal energy, k_{B}T, where k_{B} is Boltzmann's constant and T is absolute temperature in Kelvin), including, but not limited to, a nanofluidic orifice. For example, analyte(s) or interferents that flow into the outlet trough through a nanochannel of one device do not flow backwards from the outlet trough through a nanochannel of the same device. In another example, analyte(s) or interferents that flow into the outlet trough through a nanochannel of one device do not flow backwards from the outlet trough through a nanochannel of a different device toward an inlet sample via or an inlet sink via.

### II. Nanofluidic Chips

Certain new designs in nanofluidic chips configure them for high-volume manufacturing and also for use in multiplexed assays maintaining sample integrity (such that samples are isolated without cross-contaminations) in multiplexed devices on a nanofluidic chip. In some embodiments, such a nanofluidic chip comprises (a) at least two devices, wherein each device comprises (i) at least one sample inlet and (ii) at least one nanochannel; and (b) a detection region, wherein the at least two devices pass through the detection region and wherein the at least two devices are fluidically distinct from the inlet through the detection region, and wherein actuation energy can be applied independently to at least two devices.

In some embodiments, each device can be loaded with a different sample that remains fluidically distinct from the inlet through the end of the detection region. This allows for multiplexing by the user.

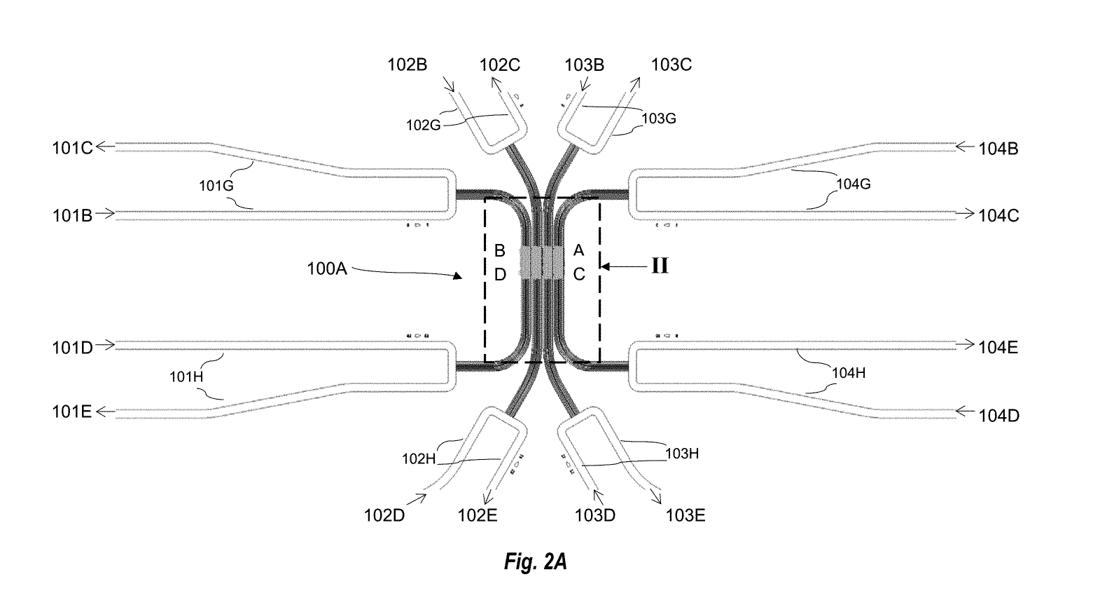

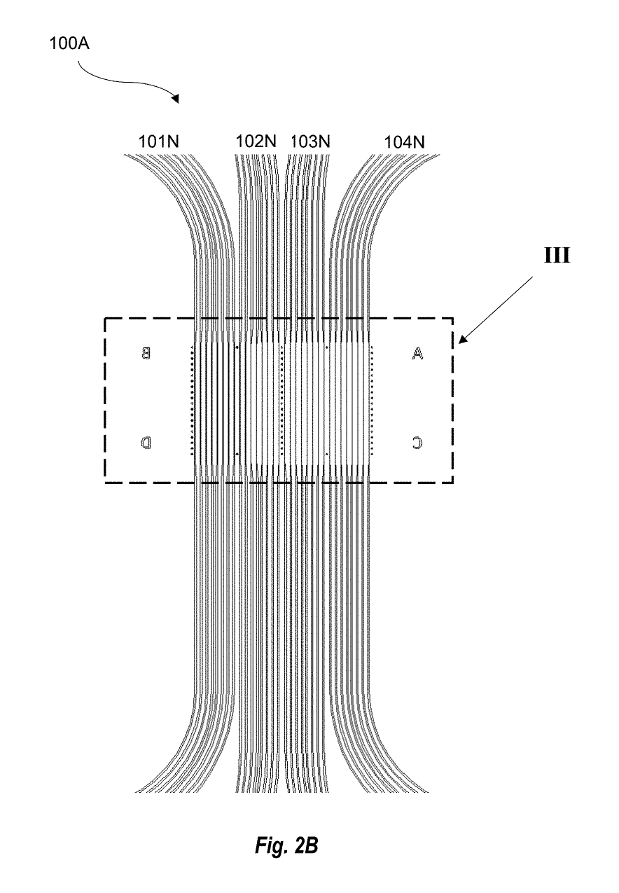

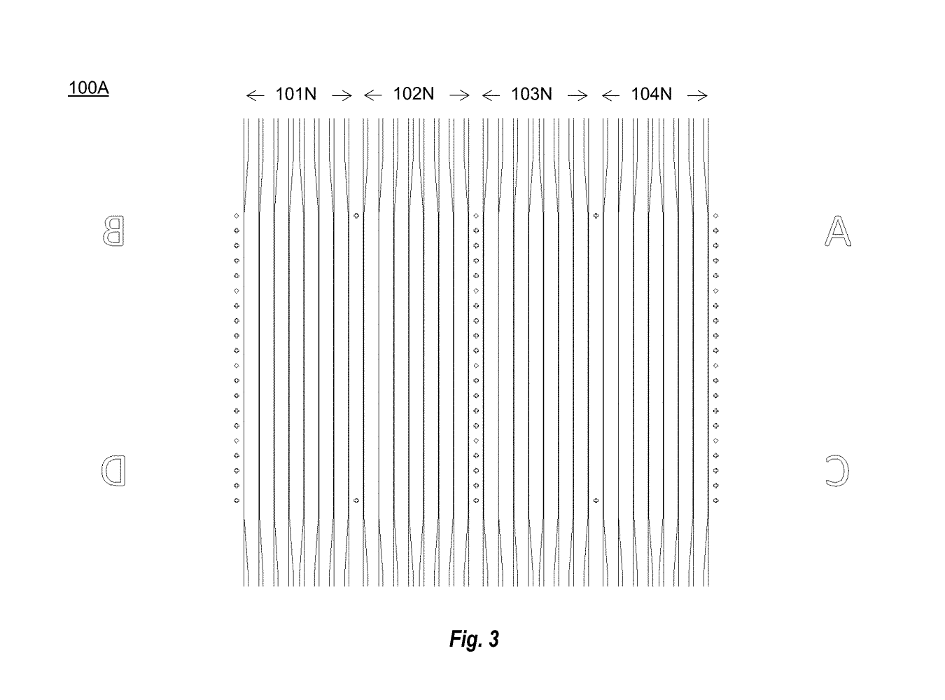

By way of simple illustration, one example of a nanofluidic chip is shown in FIGS. 1-3. In this embodiment, the nanofluidic chip 100 employs a detection region 100A. The chip of FIGS. 1-3 has four devices 101, 102, 103, 104, each with its own inlet sample via 101B, 102B, 103B, 104B, inlet sink via 101C, 102C, 103C, 104C, connected by microchannels 101G-104G, two outlet vias 101D-104D and 101E-104E, connected by microchannels 101H-104H. In this chip layout, four independent samples can be accommodated on the chip. Samples are loaded through inlet sample vias 101B, 102B, 103B, 104B, flow through the nanochannels 101N-104N, and flow out through outlet vias 101E-104E. As shown in FIGS. 2A-2B, the samples from each device flow through nanochannels 101N-104N, from the inlet side microchannels 101G-104G to the outlet side microchannels 101H-104H, passing through the detection region 100A (FIG. 3).

As shown in FIG. 2A, each set of micro channels 101G-104G corresponds to a different sample or device, and they all converge to a single region 100A. In this design, the microchannels 101G-104G and 101H-104H are a set from which nanochannels 101N-104N emanate instead of a single microfluidic channel that ends at the nanofluidic channels. Fluid priming, washout and replacement is facilitated because of the much higher volumetric flow rates through microchannels compared to nanochannels. In addition, if the sample has particulates or debris, the nanochannels are much less likely to be clogged. In this design, eight nanochannels 101N emanate from each set of microfluidic channels 101G for detection alongside and multiplexed with nanofluidic channels 102N-104N from three other devices or samples, all fitting in the detection region 100A, as shown in FIG. 2B. FIG. 3 presents a zoomed-in view of Box III of FIG. 2B, showing enhanced detail for the detection region 100A. Note that there are four devices, each of which has eight nanofluidic channels 101N-104N. Each of the four devices is separated by either two or twenty landmark features (diamonds and crosses), which can facilitate chip positioning, yet may not impact fluidic function of the device.

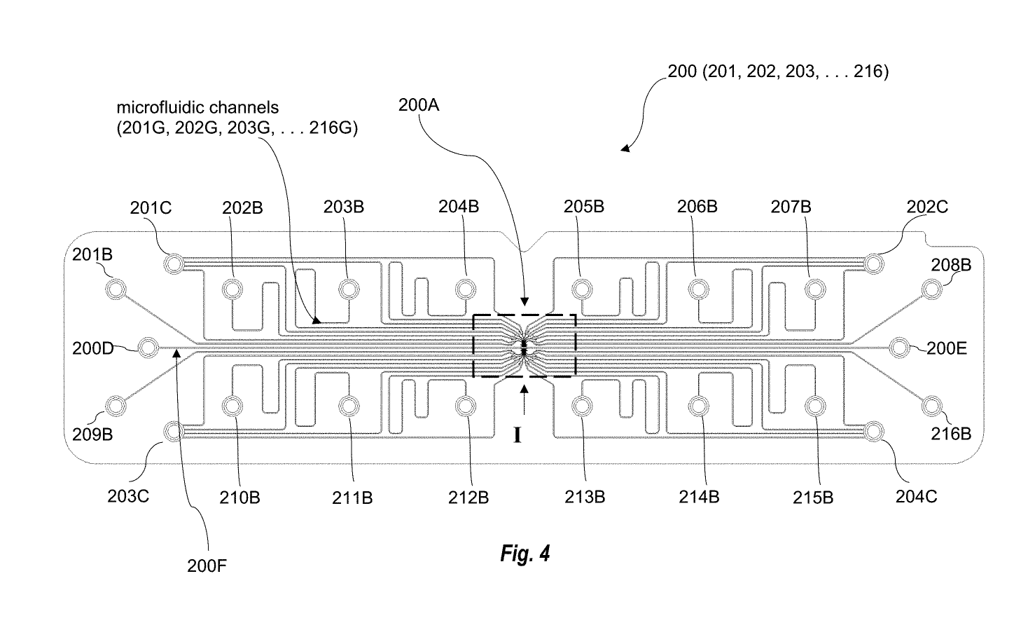

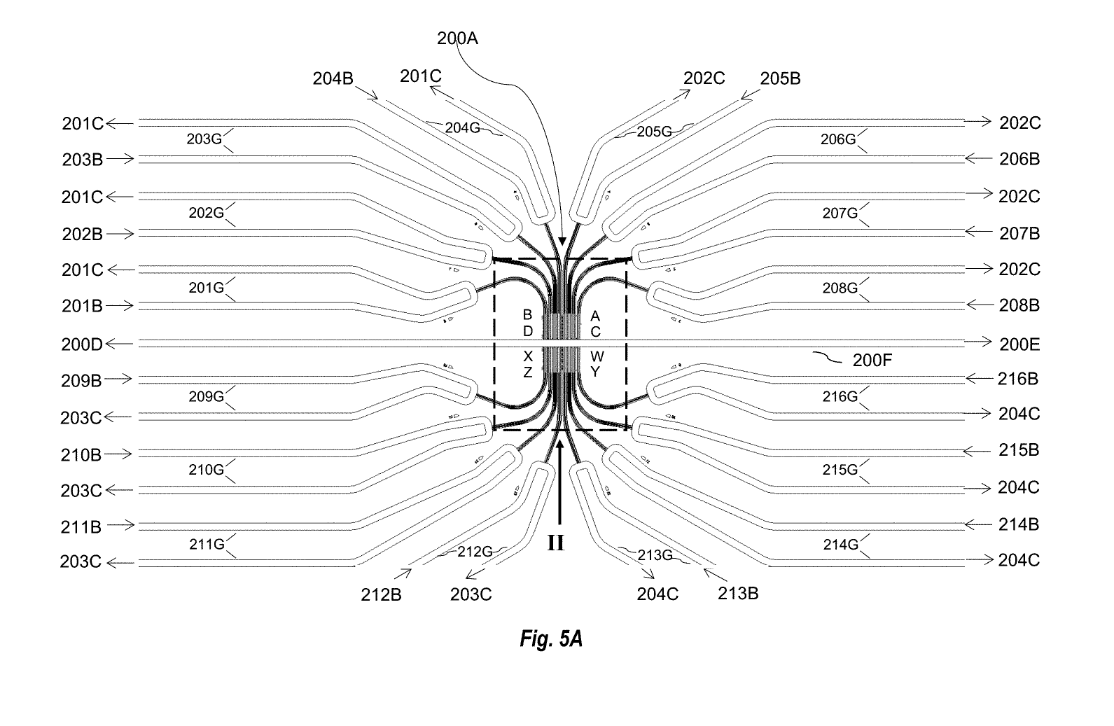

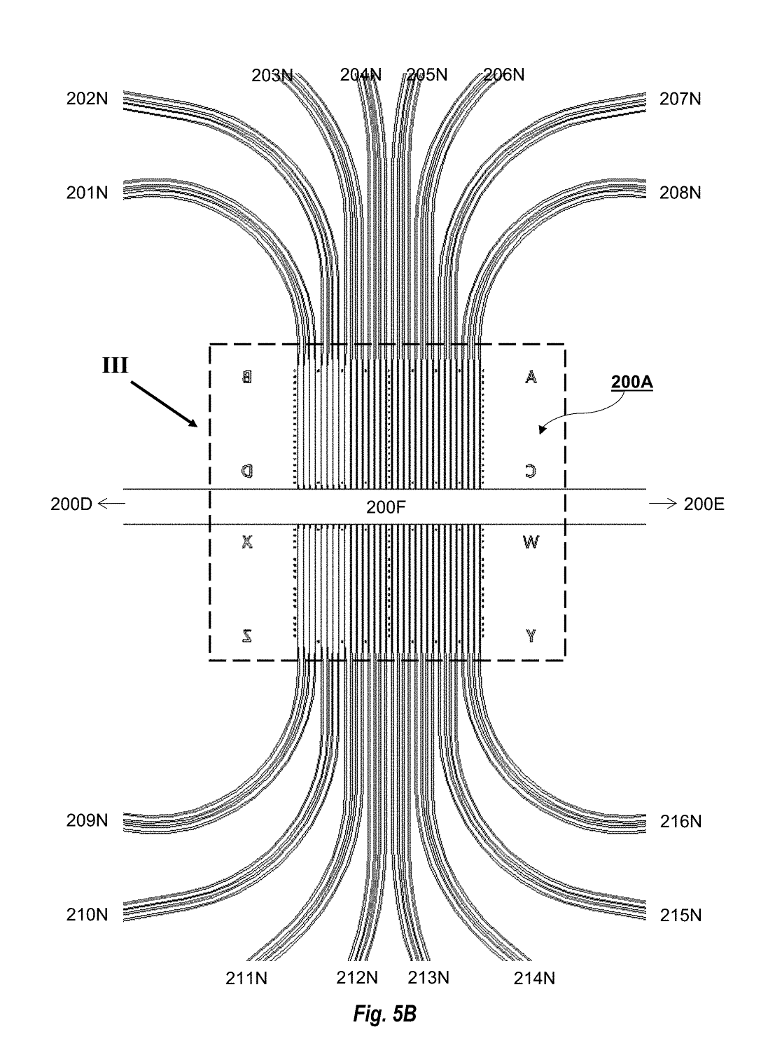

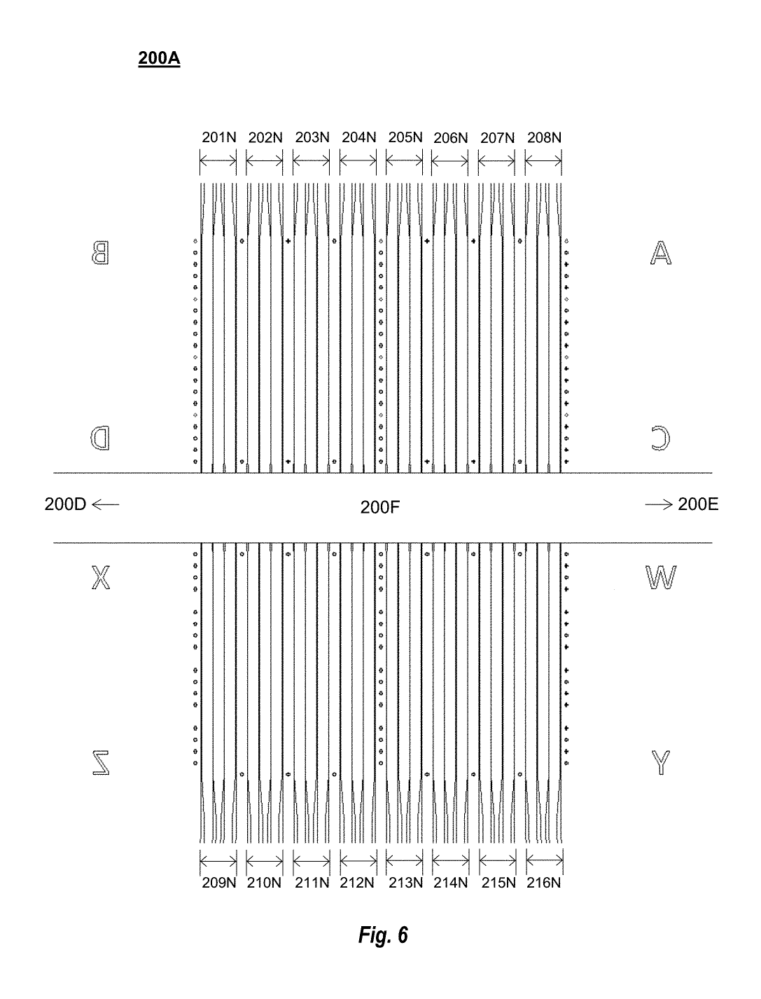

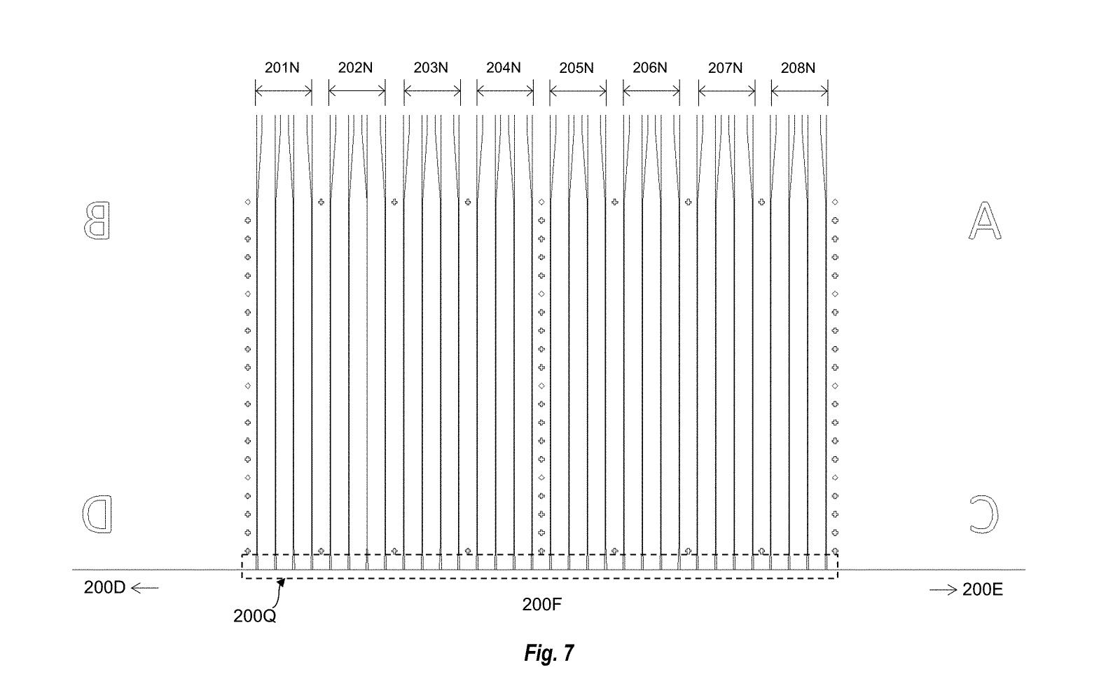

FIG. 4 provides a top planar view of one nanofluidic chip 200 having two detection regions 200A and an entropic barrier. The chip of FIG. 4 comprises 16 distinct devices 201-216, each with their own inlet sample vias 201B-216B. In FIG. 4, the chip comprises four inlet sink vias (201C: for devices 201-204, 202C: for devices 205-208, 203C: for devices 209-212, and 204C: for devices 213-216, where, for example, the four devices 201-204 that share the sink vias 201C have four micro channels 201G-204G, one per device, that connects to the inlet sink 201C) and two outlet vias 200D and 200E (connecting to each other through a common outlet trough 200F and providing an outlet shared by all 16 devices). The device may be primed using (1) one outlet via as a priming inlet and the other as a priming outlet and/or using the inlet sample via or the inlet sink via as a priming inlet and the other as a priming outlet. As shown in FIGS. 5A and 5B, each sample may be loaded in each distinct device using the inlet sample vias 201B-216B, flow through the microchannels 201G-216G and nanochannels 201N-216N, and flow out the outlet vias 200D and 200E, as shown in FIGS. 5A-5B. In this embodiment, as shown in FIGS. 6 and 7, there are four nanochannels per device (201H-216H). Devices 201-216 are separated by either two or twenty landmark features (diamonds and crosses), which can facilitate chip positioning, yet it may not impact fluidic function of the device. In some embodiments, as shown in FIG. 7, a nanofluidic orifice 200Q exists between a common trough 200F and the nanochannels 201N-216N in the detection region, constituting an entropic barrier such that contaminants or analytes that flow into the outlet trough through a nanochannel of one device will not flow backwards from the outlet trough through a nanochannel of the same or a different device toward an inlet sample via or inlet sink via.

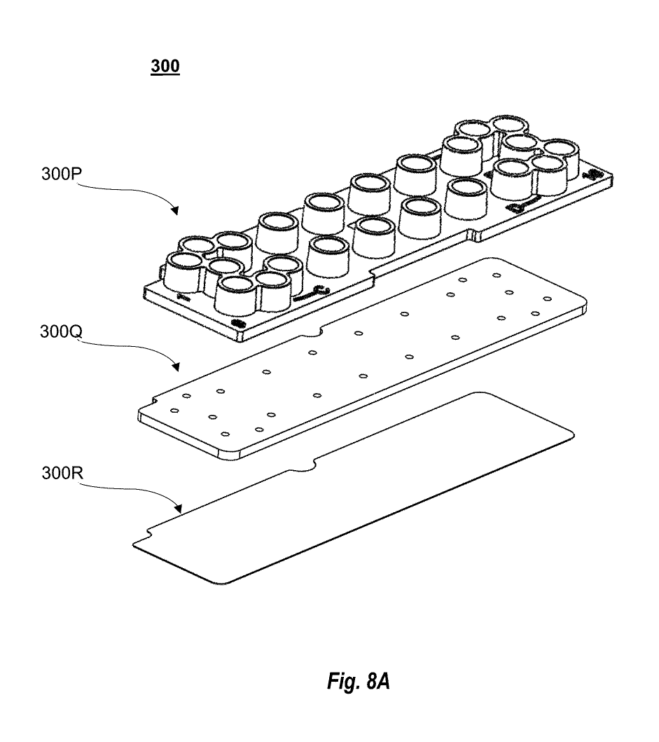

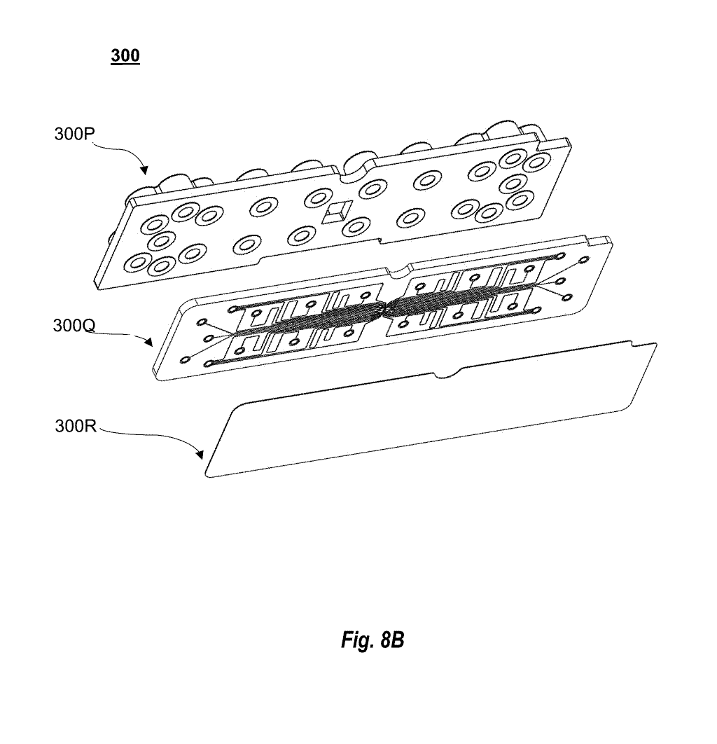

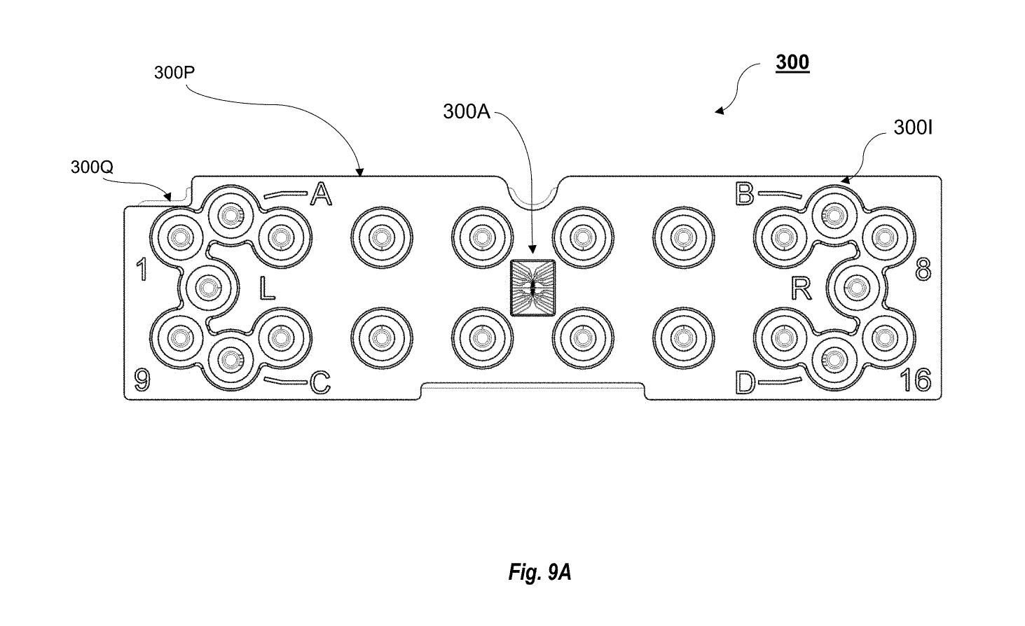

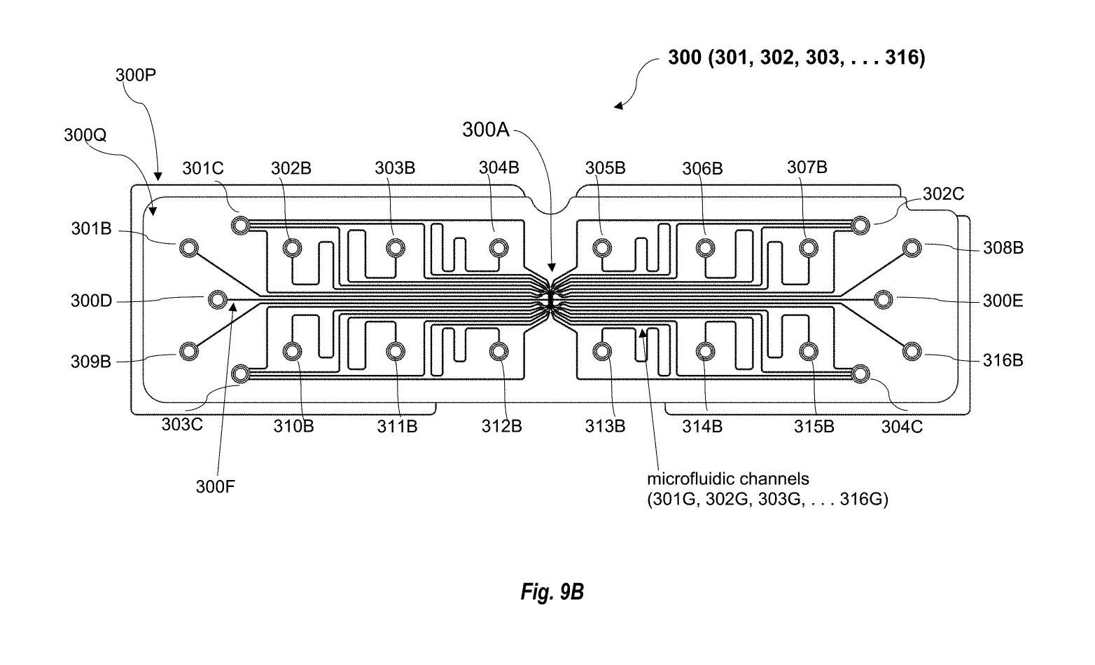

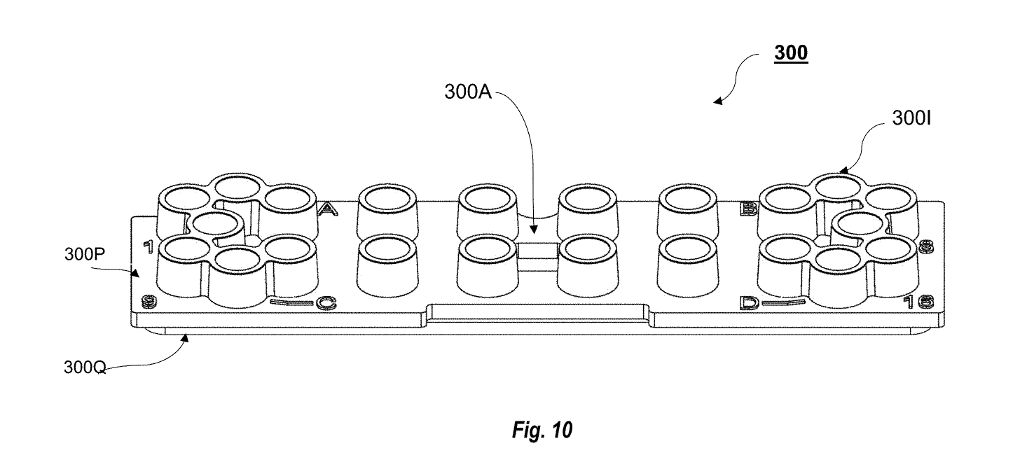

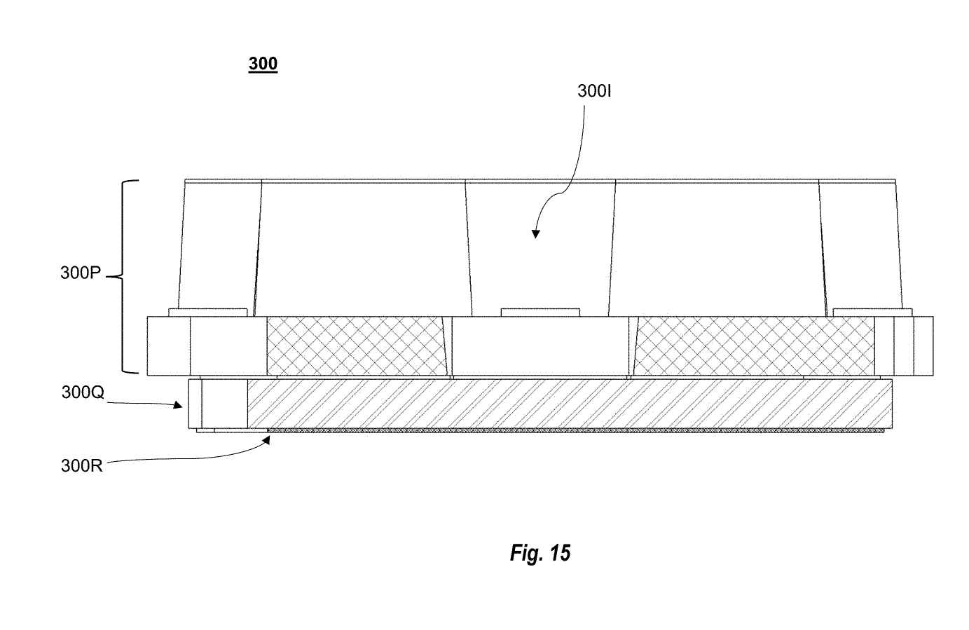

One embodiment of a nanofluidic chip 300 having a three-layer structure is shown in FIGS. 8A-10 and 15. As shown in FIGS. 8A and 8B, the nanofluidic chip 300 has a molded via layer 300P, a molded fluidic chip layer 300Q, and a bonded film layer 300R. FIGS. 9A and 10 illustrate the reservoirs 300I on the molded via layer 300P of the assembled nanofluidic chip 300. FIG. 9A shows the detection regions 300A in the center of the chip 300, and FIG. 9B shows the bottom of the detection regions 300A in the center of the chip 300. FIG. 15 shows a reservoir 300I with respect to the molded via layer 300P, the molded fluidic chip layer 300Q, and the bonded film layer 300R of the three-part structure of the chip 300.

As shown in FIG. 9B, this chip 300 includes 20 vias, with 16 inlet sample vias 301B-316B, 2 outlet vias 300D and 300E, and 4 inlet sink vias 301C-304C. Devices 301-304 are connected to inlet sink via 301C and devices 305-308 are connected to inlet sink via 302C. Devices 309-312 are connected to inlet sink via 303C and devices 305-308 are connected to inlet sink via 304C. The common trough 300F on the outlet side connects to the nanochannels 301N-316N of all sixteen devices, while also connecting to the two outlet vias 300D and 300E. FIG. 10 shows a side view of the outside of this chip 300, showing the exterior surface, the detection region 300A, and the reservoirs 300I. Sample may be loaded in the reservoirs 300A, which then fluidically couple to fluidic channels.

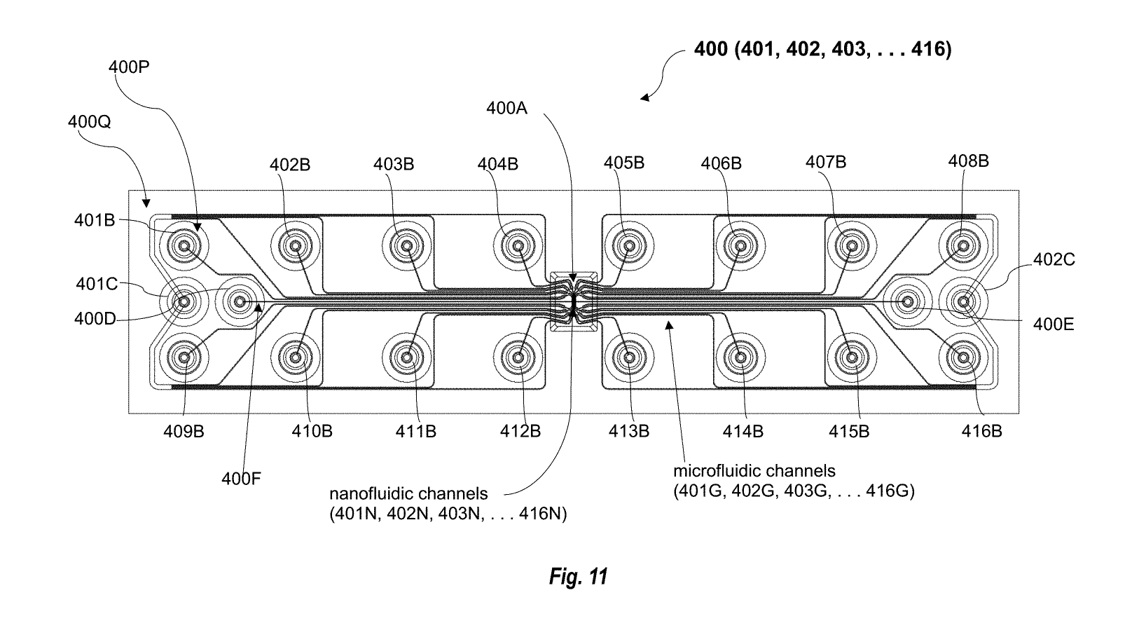

FIG. 11 shows another embodiment of a nanofluidic chip 400 having a three-layer structure with a molded via layer 400P, a molded fluidic chip layer 400Q, and a bonded film layer 400R (not shown). The molded fluidic chip 412 includes detection region 400A and 20 vias, with 16 inlet sample vias 401B-416B, 2 outlet vias 4001D and 400E, and 2 inlet sink vias 401C and 402C. Devices 401-404 and 409-412 are connected to one inlet sink via 401C and devices 405-408 and 413-416 are connected to the other inlet sink via 402C. The common trough 400F on the outlet side connects to the nanochannels 401N-416N of all sixteen devices 401-416, while also connecting to the two outlet vias 401D and 401E.

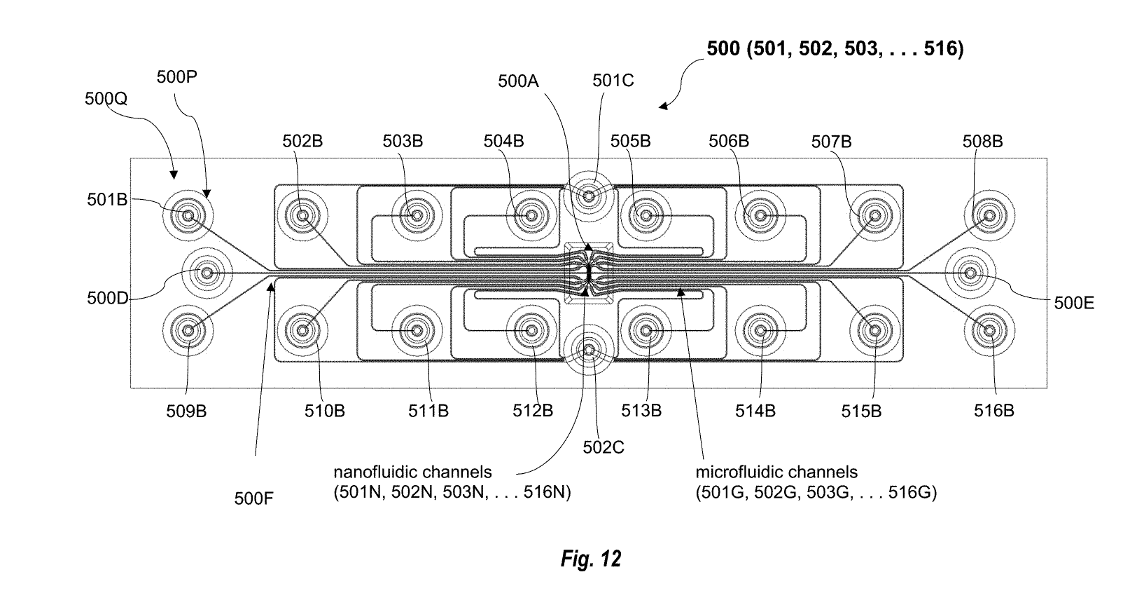

FIG. 12 shows another embodiment of a nanofluidic chip 500 having a three-layer structure with a molded via layer 500P, a molded fluidic chip layer 500Q, and a bonded film layer 500R (not shown). The chip 500 includes detection region 500A and 20 vias, with 16 inlet sample vias 501B-516B, 2 outlet vias 500D and 500E, and 2 inlet sink vias 501C and 502C. Devices 501-508 are connected to a single inlet sink 501C and devices 509-516 are connected to the other inlet sink 502C. All 16 devices 501-516 connect to a single common trough 500F, which itself is connect to two outlet vias 500D and 500E.

A. Multiplexing of Devices

In some embodiments, the nanofluidic chips comprise many more devices, allowing for higher order multiplexing of experiments, while maintaining sample integrity and convenience for the user of the chip. The chip may comprise more than one device, such as at least 2, 3, 4, 5, 6, 7, 8, 9, 10, 12, 14, 16, 18, 20, 22, 24, 30, 40, 50, 60, 70, 80, 90, 96, or more devices. Each device may comprise a single nanochannel or it may comprise multiple nanochannels. In some embodiments, each device comprises 1, 2, 3, 4, 5, 6, 7, 8, 10, 16, 20, 30, 50, 70, 100, 200, 300, 400, 500, 600, 700, 800, 900, 1000, 1200, 2400, 3600, 4800, or 5000 nanochannels. Thus, on a nanofluidic chip, there may be the same number of nanochannels as devices or there may be many more nanochannels than devices. For instance, the nanofluidic chip may comprise a total of at least 2, 4, 6, 8, 10, 16, 18, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 100, 150, 200, 250, 300, 350, 400, 450, 500, 550, 600, 650, 700, 750, 800, 850, 900, 1000, 1100, 1200, 1300, 1400, 1500, 1600, 1700, 1800, 1900, 2000, 3000, 4000, 5000, 6000, 7000, 8000, 9000, or 10,000 nanochannels that pass through the detection region. In some embodiments, on a nanofluidic chip, each device comprises a same buffer but a different sample. In some embodiments, on a nanofluidic chip, each device comprises a same sample but a different buffer.

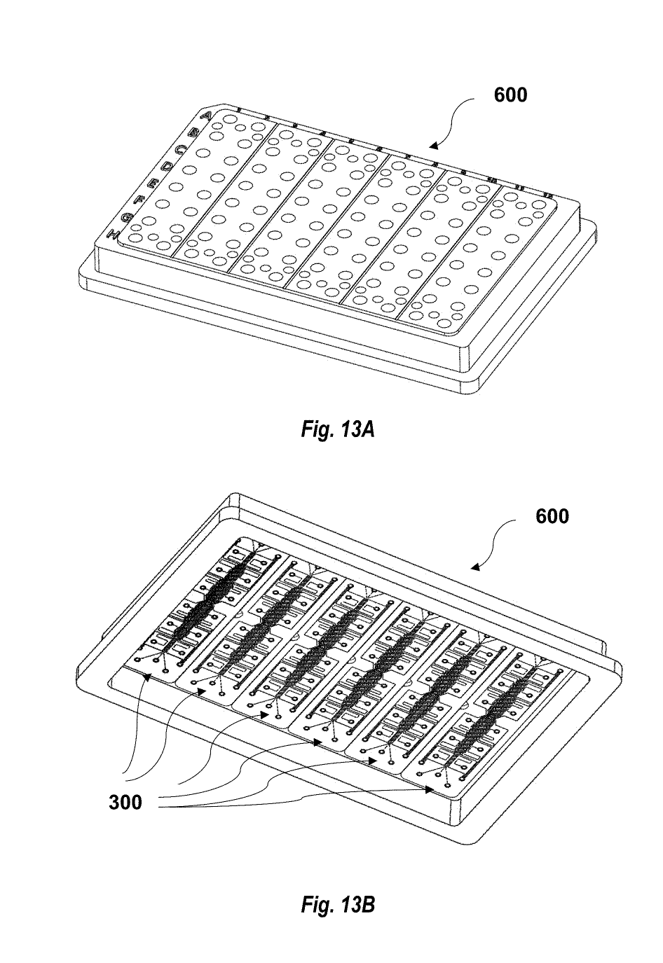

Multiple nanofluidic chips can be assembled into a frame, either by the ultimate user or during manufacturing. In some embodiments, a frame can hold 2, 4, 6, 8, or 10 chips. In some embodiments, 96 devices (or another multiple of 16 devices) are assembled into a frame (for example 6 chips with 16 devices each, assembled into a plastic frame via a laser welding process) so that it is very convenient for the user to perform multiplex detection from samples in a 96-well plate format upstream of loading them onto the nanofluidic chip. In another embodiment, chips may be slid into one or more frames at point of use, such that the customer tailors the number of chips to their particular experiment. Each frame may handle 6 chips, for example, accommodating a total of 96 samples. For example, FIGS. 13A and 13B show a frame 600 holding 6 chips 300, accommodating a total of 96 samples. In lieu of a frame, a number of chips may be molded or bonded together to create a molded piece that has a number of chips to accommodate a larger number of samples, for example 6 chips to accommodate 96 samples. In one example, multiple frames can then be stacked in an apparatus to achieve even higher throughput per run.

B. Operable for Simultaneous Detection

In some aspects, the nanofluidic chip can be used for simultaneous detection across multiple devices (either some or all of the devices on the nanofluidic chip). In other words, the nanofluidic segments may be routed such that they can all be viewed in a single detection region or in a few detection regions. In some embodiments, the detection region is clustered in one small area of the chip. This can, in some modes, allow for a single detection region for some or all devices within a single field of view of a microscope objective. For example, the single detection region for some or all devices may be in a single field of view of a microscope objective that is at least a 5×, 10×, 20×, 40×, 50×, 60× or 100× objective. In another example, the detection region is designed to couple to excitation light (e.g., a band of light, an array of light excitation regions, etc.) and/or a detector (e.g., an array of PMT detectors).

The detection region may have an area of from 400 μm² to 25 mm². In some embodiments, the detection region has an area of from 50,000 to 150,000 μm². In some embodiments, the detection region has an area of from 80,000 to 110,000 μm² microns.

The width of the detection region may be up to 10 mm. In some embodiments, the width of the detection region is at least 20, 50, 100, 120, 200, 240, 300, 320, 600, 1200, 2400, or 3000 The width of the detection region may be from 200 to 500 The width of the detection region may be from 3 to 10 In some embodiments, the detection region has a width of 300, 320, or 600 In some embodiments, the detection region has a width of 20 μm. In some embodiments, the detection region has a width of 5 μm. The length of the detection region is at least as long as the size of the laser spot used for excitation. The length of the detection region may be up to 5 mm, or from 1 μm to 5 mm. The length of the detection region may be from 200 to 400 μm. In some embodiments, the chip has a detection region with both length and width of 20 μm (constituting an area of 400 μm²). In some embodiments, the chip has a detection region with both length and width of 5 mm (constituting an area of 25 mm²). In some embodiments, the chip has a detection region with its width up to 5-10 mm and its length of 1-5 mm.

In some embodiments, the nanochannels located within the detection region are densely spaced to minimize the size of the detection region (and/or maximize the number of nanochannels that can fit in the detection region), but nanochannel to nanochannel spacing is sufficient to avoid optical crosstalk during the analysis/detection process. For example, in some embodiments, the nanochannels in the detection region are spaced at least 10 μm apart. In some embodiments, the nanochannels in the detection region are spaced at least 0.5, 1, 5, 10, 15, or 20 μm apart. The nanochannels may also comprise, for example, a 300-nm cross-section, and a length of 200 μm.

Therefore, in one embodiment, vias may be spaced across a chip, with fluidics connecting each via that converge towards a detection region. The nanochannels may then route in parallel in a closely-packed arrangement, such that there is a high density of nanochannels per unit area. For example, the density of nanochannels may be 32 nanochannels per 300 μm width, where sets of four nanochannels correspond to a single device with 8 adjacent devices. There may be an adjacent set of 32 nanochannels on the other side of the chip, in a second detection region, in one embodiment. Density may be higher or lower. Channels may be 300 μm long, longer or shorter. Fluid may flow from the inlet sample vias through fluidics, then into a nanochannel for detection, then into a common outlet (such as a common trough).

In one embodiment, the detection region may fit to or within a field of view of a 40×/0.95 NA lens, such that data can be collected simultaneously from a parallel array of nanochannels. Similarly, in one embodiment the detection region may be designed to match capabilities of an excitation device and/or a detector. For excitation, the detection region could match a laser (e.g., diffraction element to span array), a scanning laser spot, etc. For detection, the detection region could match capabilities of a photomultiplier tube (PMT) array, photodiode array, single PMT, avalanche photodiode (APD), or CMOS (complementary metal-oxide-semiconductor) or CCD (charge-coupled device) cameras.

The detection region may be thinner than the remainder of the chip. In some embodiments, the detection region is from 50 to 500 μm thick and the rest of the chip is from 500 μm to 3 mm thick, not including vias. For example, the detection region may be no more than 50, 100, 150, 200, 250, 300, 350, 400, 450, or 500 μm thick. Additionally, the rest of the chip may be at least 500 μm, 750 μm, 1 mm, 1.5 mm, 2 mm, 2.5 mm, or 3 mm thick, not including vias.

1. Experimental Advantages

Having a small detection region that allows for simultaneous detection across multiple nanochannels and multiple devices provides experimental advantages. First, it may be possible to eliminate stage movement and/or multiple optics setups, eliminating high-cost components, which may reduce the cost of the instrument. Second, it may reduce the challenge for automated identification and alignment with the detection region. Third, it may allow for a shorter run time with a single optics setup. Fourth, it may allow for improved signal-to-noise ratio, extending the dynamic range of optical assays, by reducing background. This may be done by reducing the chip thickness for the portion of the chip that includes and optionally surrounds the detection region, reducing overall background during optical detection, but without adversely impacting dimensional stability of the entire chip, which may, in some embodiments, be thicker than the detection region and optionally a portion surrounding the detection region.

2. Manufacturing Advantages

Having a small detection region also delivers significant manufacturing advantages. Such a detection region may be configured to simplify the chip design, detection system, and/or the manufacturing process. This is because manufacturing tolerances and inspection criteria may be tighter for the nanochannels used in the detection region than the rest of the chip, and by clustering the nanofluidics into a single region of the chip, only a portion of the chip needs to be manufactured to the same very high standards and the remainder of the chip can be manufactured to normally high standards.

In some embodiments, if the chip has a single detection region, minor defects in the flatness or thickness of a chip will not require refocusing of the detector on the detection region. In contrast, chips with multiple detection regions require more refocusing of the detector to accommodate imperfect flatness or thickness, as the changes in thickness or flatness of a chip accumulate across larger distances on a chip.

Optical defects may also occur during chip manufacturing. If a particular manufacturing process has a defect density of X defects per unit area, then having a smaller area for optical detection decreases the probability of having an optical defect in the detection region. Optical defects can include micrometer-scale or nanometer-scale debris, inclusions, voids, nonuniformities or other manufacturing defects that can impact optical detection, but that would not necessarily impact flow through a nanochannel. Reducing the probability of optical defects would reduce the number of chips that did not meet manufacturing standards.

In some embodiments, the chips will be examined in a quality control process. If a manufacturer wishes to examine the detection region(s) to identify any optical defects, examining one detection region will reduce the time and cost to perform the quality control step as compared to a chip with a plurality of detection regions for inspection.

Thus, in one embodiment, the size of the detection region may dictate simplicity for achieving high yields with respect to number of defects in the nanofluidic detection region, bonding quality, pattern fidelity, surface roughness, or coating uniformity. In another embodiment, the size of the detection region may simplify instrument or chip design regarding detection hardware or software. In a third embodiment, the precision, accuracy, and/or dynamic range of the assay may benefit from the ability to reduce the thickness of the chip at the detection region without loss of dimensional stability. Thus, this allows for a very thin detection region for improved detection, while having an overall thicker chip for stability, durability, and ease of manufacturing.

C. Actuation Energy

The nanofluidic chip operates using an actuation energy to move a macromolecule through the nanochannels and past the detection region. The actuation energy comprises current, voltage, hydrostatic pressure, pneumatic pressure, vacuum, flow focusing, centrifugal force, and/or any approach that is known to one of ordinary skill in the art. Thus, fluid transport may be achieved by one or more of: electrophoresis (voltage or current drop), pressure-driven flow (hydrostatic, positive pressure, vacuum, centrifugal), or capillary forces.

In one embodiment, capillary forces may be used to transport analyte into and/or through the detection region. Capillary flow may result due to a positive relationship between the surface tension of the solution in the channels with respect to the air at the interface, as well as the contact angle of the solution to the surface of the channels. Other factors such as air pressure and interactions at the inlet of the chip may play a role as well. In one embodiment, the analyte may be at or near the interface of fluid, channel wall, and air. In another embodiment, the analyte may be upstream of the interface.

The chip, having different devices that are fluidically distinct from the inlet through the detection region, allows for at least two devices having an applied voltage, applied hydrostatic pressure, applied pneumatic pressure, applied vacuum, or applied centrifugal force difference between devices. In some aspects, the at least two devices have an applied voltage difference between them. In some aspects, the at least two devices have an applied current difference between them.

In some aspects, a common outlet serves as a common ground, a common voltage, a common hydrostatic pressure, a common pneumatic pressure, or a common vacuum.

In some embodiments, at least one common outlet comprises a common voltage. In some embodiments, at least one common outlet comprises a common ground voltage. In some embodiments, at least one common outlet comprises a common current. In some embodiments, at least one common outlet comprises a common fluidic pressure.

The spacing around a chip of different devices can allow for a difference in centrifugal force between devices, for example with a device nearer to the axis of rotation having a lower centrifugal force and a device further from the axis of rotation having a higher centrifugal force.

In flow focusing, the sample fluid flow (i.e., the fluid comprising the macromolecule for detection) is bound by other fluids flowing along side of it. Thus, hydrodynamic flow focusing is an approach to control the cross-sectional position, speed, mixing, and other attributes of one or more fluids flowing in parallel in a channel. For example, fluid A may comprise buffer and macromolecule to be assayed, while fluid B may comprise buffer but no macromolecule. Fluid B may serve as a “sheath fluid”. If fluid A and B flow parallel to each other in a laminar flow profile within the same channel, each will consume a proportion of the cross-sectional area, and there may be a degree of mixing due to diffusion. Increasing the volumetric flow rate of fluid A while maintaining the volumetric flow rate of fluid B may increase the proportion of the total cross-sectional area consumed by fluid A while decreasing the proportion consumed by fluid B. To maintain the same volumetric flow rate, fluid B may then flow faster, which may separate macromolecules that comprise fluid B.

D. Common Outlet

As discussed in other sections of the present application, in one embodiment, the nanochannels flow into a common outlet that provides a common waste for two or more devices. In some embodiments, the nanochannels lead into a common trough, as a type of or component of a common outlet. The common outlet may open into an outlet via or it may end in a fluid reservoir. A fluid reservoir may optionally have an air vent or it may be of a size to accommodate fluid without an air vent.

In a further embodiment, the fluidic interface between the nanochannels and the common trough may have a nanoscale orifice and/or nanochannel geometries, such that large molecules may be less likely to enter, minimizing cross-contamination. In particular, the likelihood of a DNA molecule entering a nanochannel without a favorable energy gradient (e.g., a sufficient and appropriately negative or positive voltage gradient) may be so low as to rarely or never happen in practice, such that DNA from one device may not be able to enter another device. The likelihood may be low because only a small subset of all possible conformations of a DNA molecule may pass into the channel without a favorable energy gradient (i.e., the process is entropically unlikely). Furthermore or alternatively, upon entering a nanochannel, it becomes similarly unlikely that the molecule will move through the nanochannel any appreciable distance in a period of time. Therefore, at least a portion of a nanochannel in a detection region may only be exposed to analyte or DNA from a single sample or device, not from adjacent devices.

The common outlet (such as a common trough) may minimize the number of fluidic channels needed to eliminate sample that has exited through the nanochannels and detection region, as shown by comparing FIG. 1 and FIG. 4. Reducing the number of microfluidic paths and vias simplifies the design of the chip and increases chip density (the number of devices per chip and/or the number of nanochannels per chip) because each of these elements requires its own spacing and minimum spacing between components. This may simplify the design, thereby reducing the footprint of a chip. In addition, it may simplify the manufacturing process by relaxing the distance between adjacent channels that must be fluidically distinct (i.e., bonded without defects).

In one embodiment, the devices on the chip may be run in parallel and/or serially in a single run. In another embodiment, the devices may be run over multiple experimental runs. For example, devices 1 through 18 may be run in a first experimental run, devices 19 through 55 may be run in a second experimental run, and devices 56-96 may be run in a third experimental run. Because the common trough(s) of a chip may minimize cross-contamination, different types, quality, preparations, and ages of DNA may be run through different devices during different experimental runs without cross-contamination of DNA into a detection region. In one embodiment, the DNA for each experimental run may be loaded at a single point in time. In another embodiment, the DNA may be loaded separately, before the associated experimental run.

The common trough may be beneficial not only for minimizing cross-contamination of samples from adjacent devices, whether fresh sample or not, but it may also be beneficial for minimizing foreign growth or particulate. For example, if bacteria are present in the common trough, it may be too large to enter the nanochannels that empty into the common trough, such that the nanochannels and, in particular, the detection regions of the nanochannels, remain clear of bacteria. In another example, if a bacterium secretes a compound that is a potential interferent, even if the compound is small enough to diffuse into the nanochannel without difficulty, the length vs. the cross-sectional area of the nanochannel may make diffusion far upstream unlikely. In yet another example, the reservoirs may be imbalanced such that there is a small hydrostatic pressure head from inlets to the common trough, such that diffusion, if any, of small compounds is counteracted by a pressure head.

In a further embodiment, the common trough may connect to sample outlet devices, as is known in the art and described above for sample inlet devices. In another embodiment, the common trough may connect to a reservoir or may itself be a reservoir to fully contain the waste.

In one embodiment, there may be a driving potential to the outlet, such as a lower pressure, a lower voltage potential due to an electrode at the outlet via, etc.

In one embodiment, the nanoscale orifice that exits to the common trough or the nanochannel may be sized to ensure particular types of cross-contamination or contamination do not enter the trough. In another embodiment, the nanoscale orifice may widen in a more gradual transition to the common trough.

In another embodiment, a dead flow region may be designed at the nanoscale orifices such that contamination or cross-contamination is even less likely to get close to the nanoscale orifices of adjacent devices.

The common trough may have a width and/or depth that is macroscale, milliscale, microscale, or nanoscale. Its length may extend across the entire chip, across a detection region, across a portion of a detection region. In one example, the common trough may be 100 microns wide, 5 microns deep, and 7 cm long.

E. Other Features of Nanofluidic Chips and Devices

There may be fluidic features to facilitate priming, reduce air bubbles (e.g., bubble traps, particular cross-sectional aspect ratios), or reduce debris (e.g., dead zones). There may be fluidic features to enhance buffer washout.

In some embodiments, the some or all inlet microfluidics have the same length and/or volume. This may be desired in some embodiments to have the fluidics be the same, for example, it would take the same time to prime the channels, for the sample to reach the nanochannels after loading, and the like. This means that the length and/or volume of a device from the inlet through the detection region is the same length and/or volume as other devices or all devices. In some embodiments, all outlet microfluidics have the same length and/or volume, which means the length of the device from the end of the detection region through to the outlet. In some embodiments the inlet microfluidics (from the inlet through the detection region) do not take a linear path from the inlet to the detection region, but instead have curves or turns to allow for more devices to be clustered on a chip having a common detection region. By the same length and/or volume, we mean at least 90% identical. In some embodiments, the same length and/or volume may be 91%, 92%, 93%, 94%, 95%, 96%, 97%, 98%, or 99% identical.

In one embodiment, the only fluidic segment may be nanofluidic. In another embodiment, there may be other sized segments. For example, a via may empty into a microfluidic channel, which then enters into a nanochannel, which then empties into a microfluidic channel, which then exits through an exit via.

There may be one inlet sample via or multiple inlet vias (with one inlet sample via and one or more inlet sink vias for priming purposes) in a device. For example, debris or clogging of nanofluidics may be reduced by priming a chip through microfluidics only, instead of forcing all liquid through the nanofluidics. By incorporating inlet sink vias, this can improve priming.

In some embodiments, the entire nanochannel may have nanoscale width, depth, and/or diameter, while in other embodiments, the cross section of at least a portion of the length of the nanochannel may be larger.

F. Materials, Composition, and Fabrication of the Nanofluidic Chip

Chip material may be comprised of any material as is known in the art. For example, one or more of plastic; glass or fused-silica; silicon; silicone or elastomer; adhesive or pressure sensitive adhesive; conductive material such as electrodes (e.g., carbon, metal); and coatings. In some embodiments, the nanofluidic chip is made of plastic. In some embodiments, the nanofluidic chip is made of injection-molded plastic.

Channels may be fabricated via any fabrication method known in the art. In one embodiment, a patterned layer may be bonded to a second layer. The second layer may be patterned or flat. Additional layers may be added, if desired or required, to add functionality, parallelize, etc.

Patterning of nanochannels may be accomplished via any method as is known in the art. In one embodiment, chips and devices are nanopatterned directly by a nanofabrication technique: for example, one or more of etching, photolithography, x-ray lithography, electron beam lithography, dip pen lithography, micromolding in capillaries (MIMIC), microtransfer molding, laser etching, high precision milling, electron discharge machining (EDM), focused ion beam (FIB) milling, nanoimprint lithography, etc. In another embodiment, a master may be patterned by a nanofabrication technique, and the master may be directly used in construction of nanopatterned chips or devices. In yet another embodiment, the master may be patterned by a nanofabrication technique, and then the master may be used as a mold to directly or indirectly pattern a tool for molding (e.g., injection molding). Other molding techniques may be used alternatively or additionally, such as hot embossing or vapor polishing, as is known in the art. In some embodiments, the vias are created using boss features.

In one embodiment, the master or mold may be fashioned with a draft angle to facilitate separation of the chip from the mold or master, or the mold itself from the master.

Bonding may be performed by any method as is known in the art. For example, one or more of pressure sensitive adhesive or tape, solvent assisted bonding, adhesive, plasma treatment or surface modification, conformal contact, laser welding, ultrasonic bonding, thermal bonding approaches, anodic bonding, induction welding, and clamping.

In one embodiment, the surfaces may be modified to facilitate the assay, to perform the assay, or for other reasons. Modification may comprise plasma treatment, corona treatment, ozone or UV treatment, wet treatment (e.g., KOH), vapor polishing, or vapor deposition.

In one embodiment, additives may be on the chip in wet and/or dry form. For example, the chip may comprise: biochemical buffer or assay components, coatings, reagent, preservative, lysis components, dyes, etc.

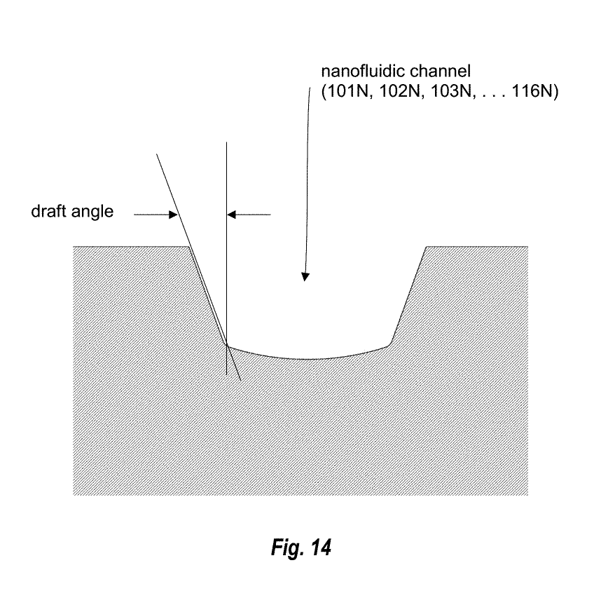

In some embodiments, the nanochannel walls have a tapered profile constituting a draft angle. FIG. 14 shows an example of nanochannel walls having a tapered profile constituting a draft angle. In some embodiments, a method of producing the nanofluidic chips described herein comprise producing a plastic nanofluidic chip using injection molding and fabricating the nanochannels with focused ion beam (FIB) milling, creating a draft angle. Thus, in some embodiments, a method of producing the nanofluidic chips described herein results in nanochannel walls having a tapered profile constituting a draft angle. The draft angle (θ) may be 0°<θ<90°. In some embodiments, the draft angle may be any degree ranging up to 90°, up to 60°, up to 45°, up to 30°, or up to 15°. In some embodiments, the draft angle is 0.5, 1, 1.5, 2, 2.5, 3, 3.5, 4, 4.5, 5, 5.5, 6, 6.5, 7, 7.5, 8, 10, 15, 20, 25, 30, 35, 40, or 45 degrees (°).

In one embodiment, there is a capacity to detect and/or track whether devices on a chip are used or unused. For example, an associated instrument may detect analyte in nanochannels of devices 1 through 8, but no analyte in devices 9 through 16. The instrument may store this information on an RFID sticker that is on the chip. Upon re-use, the instrument may read the information contained in the RFID sticker, indicating which devices have been used or not used. The instrument may only run, analyze, and/or present information for devices that have not previously been used.

G. Detection

The nanofluidic chips work in partnership with a detection system. The detection system may be any as is known in the art. For example, one or more of: colorimetric optical; fluorescence, phosphorescence, luminescence, etc.; and electrical (voltage, impedance, current, capacitance).

Design factors may comprise: a detection region configured to align and interface with the working distance of an optical lens, a laser, a CMOS or CCD camera, APD (avalanche photo diode) detector, and/or a PMT (photomultiplier tube) detector, minimal background fluorescence, and a means for connecting electrical contacts to the instrument. The detector may operate to detect analyte from one or more than one nanochannel simultaneously, where the nanochannels may be from a single device and/or multiple devices.

Assay optimization to optimize and stabilize both signal and background or drift may employ methods as is known in the art.

### III. Methods of Using the Nanofluidic Chips

The present nanofluidic chips may be used for a plurality of different assay types. Assays may be performed for size determination of an analyte, including average size and coefficient of variation (CV). Assays may also look quantitatively at a sample to determine the number of analyte molecules per volume or with respect to other populations of analyte or one or more markers. Assays may also provide other information related to the analyte, such as microbial strain typing.

The nanofluidic chip may be used in an assay to detect, assess, monitor, or grow an analyte. The analyte may be at least partly biological, chemical, inorganic, and/or physiological. For example, the analyte may be a macromolecule, a polymer, DNA, RNA, or a nucleic acid, a protein, a contaminant, a cell, a bead, a bead adhered to a biological component, etc. The analyte may be bound to one or more molecules or types of molecules inherent to the assay or assay performance: for example, they facilitate detection (e.g., intercalation dye), facilitate enzymatic cleavage, or protect the analyte from damage (e.g., an antioxidant).

As an analyte, DNA (also including other forms of nucleic acids) may be evaluated to determine its size and to provide quality control metrics after DNA sequencing. DNA may also be assessed through detection of agglomerates. Apoptosis assays may also be performed in cancer research.

Long reads of DNA (also including other forms of nucleic acids) may also be evaluated and sized on the nanofluidic chips. This allows for microbial strain typing. Pathogen identification may also be conducted to identify the exact pathogen causing an infection and avoid or reduce problems with antibiotic resistance. Pathogen identification may also be employed for sanitation reasons in medical facilities or in the food industry. In some embodiments, DNA may be collected from the nanofluidic outlet after sizing for post-processing or use in a mixed format.

DNA (and other forms of nucleic acids) may also yield additional information on the nanofluidic chips through a DNA/nucleic acid mapping process. DNA/nucleic acid may be cleaved into fragments before sizing, yielding further information. Labels that bind specifically to unique nucleotide sequences, for example, to certain nucleotides (e.g., preferentially to GC over AT nucleotides), or to certain epigenetic modifications may be detected to yield further information about nucleic acids.

Other forms of single molecule detection may also occur on the nanofluidic chips including protein sizing with an amine binding dye (e.g., A20000, Invitrogen); RNA sizing or detection; digital assays with DNA, RNA, and/or other nucleic acids; DNA fingerprinting (for forensic, medical, pathogen, or GMO testing).

In some embodiments, a method of analyzing at least one biological sample in fluid form on the nanofluidic chips disclosed herein comprises loading a biological sample onto one or more devices using a sample inlet, flowing the biological sample through the nanochannel, and conducting a detection step.

In some embodiments, the biological sample comprises a polymer. In some embodiments, the biological sample comprises an analyte. In some embodiments, the analyte comprises nucleic acids. In some embodiments, the biological sample is suspected of comprising a contaminant. In some embodiments, the biological sample comprises a living component. In some embodiments, the living component comprises bacteria. In some embodiments, the living component comprises mold.

In some embodiments, the method comprises analyzing at least one biological sample on a first device at a first time point and analyzing at least one biological sample on a second device on the same nanofluidic chip at a second time point. Because the devices are fluidically distinct from the inlet through to the end of the detection region, in some embodiments, and because in additional embodiments a nanofluidic orifice exists between any common trough and the nanochannels in the detection region, no contamination occurs between devices. The nanofluidic orifice and/or nanochannel(s) create(s) an entropic barrier such that contaminants will not diffuse from the outlet backwards into the nanochannels even in the absence of electric fields or pressure gradients countering such backward flow. Unused devices remain suitable for additional runs on future days. This allows a user to reuse a chip if some but not all devices are employed on a first experiment and the user wishes to avoid waste and use the remaining devices in one or more additional experiments. In some embodiments, the time between the first experiment on a chip using some of the devices and a subsequent experiment using other devices may be at least 4 hours, 6 hours, 12 hours, 14 hours, 24 hours, 2 days, 3 days, 4 days, 5 days, 6 days, or 7 days, 2 weeks, 1 month, 3 months, 6 months, 9 months, 1 year, 2 years, 3 years.

Thus, the nanofluidic devices have significant utility in the art.

Fluid may be primed before the assay begins or during the assay. Chips may be pre-primed during production or primed by the customer at time of use.

Sample entry to the device may be achieved by any technique as is known in the art. For example, one or more of via, tubing interface, hole or orifice.

### EXAMPLES

### Example 1: A Nanofluidic Chip with a Single Detection Region

A nanofluidic chip is manufactured, as described in FIG. 1-3. This nanofluidic chip has an array of nanochannels that are spaced such that the fluorescent signal from the individual channels (i.e., samples) can be detected simultaneously from within the field of view of a 40×/0.95 NA lens. The nanochannels have a 300-nm cross section (width and depth), a length of 200 and are separated by 10 μm center-to-center. The array design is contained within an area that is 320 μm wide by 200 μm long. The array consists of 32 channels grouped into 4 sets of 8 channels (FIG. 3, 101N, 102N, 103N, 104N) per sample path. The array allows for 4 individual samples (or devices) to be analyzed, one sample per 8 nanochannels. Because the detection region is localized to a single minimized area of the chip, the instrument can simultaneously interrogate and detect from a single region, instead of travelling serially to 4 different regions. In addition, the manufacturing yield is increased over a chip with 4 separate detection regions. Per a given density of optical defects that could impact detection by localized background increase or aberrant scattering, a chip may be less likely to have an optical defect in a detection region given that the total combined area of detection regions is 4× smaller. In addition, the flatness of the nanochannel plane may be easier to achieve in a single detection region than across 4 detection regions that would span a longer portion (for example, up to 2″) on a chip, such that it is easier to find and maintain focus. In FIG. 1, each device requires 4 vias (1 inlet sample, 1 inlet sink, 2 outlets)

### Example 2: A Nanofluidic Chip with Single Detection Region and Common Trough

In a related example to Example 1, manufacturing of the chip described in Example 1 may reduce the cost and/or time of quality control. A microscope inspection system may automatically inspect and identify any functional defects in chips during or after manufacturing. If 100% inspection is only needed in the detection region(s), reduction from 4 to 1 detection region may reduce the inspection time by 4×, reducing chip cost.

### Example 3: A Nanofluidic Chip with Single Detection Region and Common Outlet

A nanofluidic chip is manufactured as described in FIG. 4-7. This chip has a single detection region as well as a common outlet (such as a common trough). The chip is the same size as the chip of Example 1, but this chip can handle 16 separate samples or devices, instead of 4. This is true despite an exemplary design constraint of both chips, requiring a way to prime the inlet and outlet microfluidic paths without forcing liquid through the nanofluidics. The chip density is four times higher because the inlet sink and the outlet are shared. In particular, each device employs 1.375 vias (1 inlet, 0.25 inlet sink (1 sink per 4 devices), 2/16 outlets (2 outlets shared across all 16 devices). In other words, this chip has 22 vias for 16 devices. The increased chip density lowers the cost per data point.

### Example 4: A Nanofluidic Chip with Thinner Detection Region

In one example, reduction from 8 to one detection region may facilitate for the detection region to be molded with a thinner plastic, while retaining the thickness of the surrounding chip and associated dimensional stability. In that case, the detection region may have a thickness of 500 micrometers, while the surrounding chip may have a thickness of 1 millimeter.

### Example 5: Certain Embodiments

Item 1. A nanofluidic chip configured for high-volume manufacturing and maintaining sample integrity in multiplexed devices comprising:
a. at least two devices, wherein each device comprises
   i. at least one sample inlet and
   ii. at least one nanochannel; and
b. a detection region,
   wherein the at least two devices pass through the detection region and
   wherein the at least two devices are fluidically distinct from the inlet through the detection region, and
   wherein actuation energy can be applied independently to at least two devices.

Item 2. The nanofluidic chip of item 1, wherein the chip comprises more than one device, such as at least 2, 4, 6, 8, 10, 12, 14, 16, 18, 20, 22, or 24 devices.

Item 3. The nanofluidic chip of any one of items 1-2, wherein each device comprises 1, 2, 3, 4, 5, 6, 7, 8, 10, 16, 20, 30, 50, 70, 100, 200, 300, 400, 500, 600, 700, 800, 900, 1000, 1200, 2400, 4800, or 5000 nanochannels.

Item 4. The nanofluidic chip of any one of items 1-3, wherein the nanofluidic chip comprises a total of at least 2, 4, 6, 8, 10, 12, 14, 16, 18, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 100, 150, 200, 250, 300, 350, 400, 450, 500, 550, 600, 650, 700, 750, 800, 850, 900, 1000, 1100, 1200, 1300, 1400, 1500, 1600, 1700, 1800, 1900, 2000, 3000, 4000, 5000, 6000, 7000, 8000, 9000, or 10,000 nanochannels that pass through the detection region.

Item 5. The nanofluidic chip of any one of items 1-4, wherein each chip comprises 16 devices with 4 nanochannels each.

Item 6. The nanofluidic chip of any one of items 1-5, wherein multiple nanofluidic chips can be assembled in a frame.

Item 7. The nanofluidic chip of item 6, wherein the user assembles multiple nanofluidic chips on a frame.

Item 8. The nanofluidic chip of item 6, wherein the multiple nanofluidic chips are assembled into a frame during manufacturing.

Item 9. The nanofluidic chip of any one of items 6-8, wherein 2, 4, 6, 8, or 10 chips are assembled into a frame.

Item 10. The nanofluidic chip of any one of items 6-Error! Reference source not found., wherein 96 devices are assembled into a frame.

Item 11. The nanofluidic chip of any one of items 1-10, wherein the detection region is configured to allow detection across multiple devices simultaneously.

Item 12. The nanofluidic chip of any one of items 1-11, wherein the detection region is observable within a single field of view of a microscope objective.

Item 13. The nanofluidic chip of item 8, wherein the microscope objective is at least a 5×, 10×, 20×, 40×, 50×, 60×, or 100× objective.

Item 14. The nanofluidic chip of any one of items 1-13, wherein the actuation energy comprises current, voltage, hydrostatic pressure, pneumatic pressure, vacuum, flow focusing, or centrifugal force.

Item 15. The nanofluidic chip of any one of items 1-14, wherein at least two devices allow for an applied voltage, applied hydrostatic pressure, applied pneumatic pressure, applied vacuum, applied flow focusing, or applied centrifugal force difference between devices.

Item 16. The nanofluidic chip of any one of items 1-15, wherein the at least two devices allow for an applied voltage difference between devices.

Item 17. The nanofluidic chip of any one of items 1-16, wherein the fluidically distinct inlets allow for an applied current difference between devices.

Item 18. The nanofluidic chip of any one of items 1-17, wherein at least one common outlet comprises a common voltage, optionally a common ground voltage.

Item 19. The nanofluidic chip of any one of items 1-18, wherein at least one common outlet comprises a common current.

Item 20. The nanofluidic chip of any one of items 1-19, wherein at least one common outlet comprises a common fluidic pressure.

Item 21. The nanofluidic chip of any one of items 1-20, wherein the detection region has an area of from 400 μm² to 25 mm², optionally from 50,000 to 150,000 square microns.

Item 22. The nanofluidic chip of any one of items 1-21, wherein the detection region has an area of from 80,000 to 110,000 square microns.

Item 23. The nanofluidic chip of any one of items 1-22, wherein the detection region has a length of from 200 to 400 microns.

Item 24. The nanofluidic chip of any one of items 1-23, wherein the detection region has a width of from 200 to 500 microns.

Item 25. The nanofluidic chip of any one of items 1-24, wherein the nanofluidic chip is made of plastic.

Item 26. The nanofluidic chip of item 25, wherein the nanofluidic chip is made of injection-molded plastic.

Item 27. The nanofluidic chip of any one of items 1-26, wherein all inlet microfluidics have the same length.

Item 28. The nanofluidic chip of any one of items 1-27, wherein all outlet microfluidics have the same length.

Item 29. The nanofluidic chip of any one of items 1-28, wherein the nanochannel walls have a tapered profile constituting a draft angle.

Item 30. The nanofluidic chip of any one of items 1-29, wherein the detection region is thinner than the other portions of the nanofluidic chip.

Item 31. The nanofluidic chip of item 30, wherein the detection region is from 50 to 500 μm thick.

Item 32. The nanofluidic chip of any one of items 30-31, wherein the chip is from 500 μm to 3 mm thick, not including vias.

Item 33. A method of producing the nanofluidic chip of any one of items 1-32, comprising producing a plastic nanofluidic chip using injection molding and fabricating the nanochannels with focused ion beam (FIB) milling.

Item 34. The method of producing a nanofluidic chip according to item 33, wherein the method results in nanochannel walls having a tapered profile constituting a draft angle.

Item 35. The method of producing a nanofluidic chip according to any one of items 33-34, wherein the draft angle is 0.5, 1, 1.5, 2, 2.5, 3, 3.5, 4, 4.5, 5, 5.5, 6, 6.5, 7, 7.5, 8, 10, 15, 20, 25, 30, 35, 40, or 45 degrees.

Item 36. The method of producing a nanofluidic chip according to any one of items 33-35, wherein the bottom side of the nanofluidic chip is sealed using a bonding process.

Item 37. The method of producing a nanofluidic chip according to any one of items 33-36, wherein the vias are created using boss features.

Item 38. A method of analyzing at least one biological sample in fluid form on the nanofluidic chip of any one of items 1-32, comprising loading a biological sample onto one or more devices using a sample inlet, flowing the biological sample through the nanochannel, and conducting a detection step.

Item 39. The method of item 38, wherein the biological sample comprises a polymer.

Item 40. The method of any one of items 38-39, wherein the biological sample comprises an analyte.

Item 41. The method of any one of items 38-40, wherein the analyte comprises nucleic acids.

Item 42. The method of any one of items 38-41, wherein the analyte comprises proteins.

Item 43. The method of item 38-42, wherein the analyte comprises viruses.

Item 44. The method of any one of items 38-43, wherein the biological sample is suspected of comprising a contaminant.

Item 45. The method of any one of items 38-44, wherein the biological sample comprises a living component.

Item 46. The method of item 45, wherein the living component comprises bacteria.

Item 47. The method of any one of items 45-46, wherein the living component comprises mold.

Item 48. The method of any one of items 38-47, wherein the method comprises analyzing at least one biological sample on a first device at a first time point and analyzing at least one biological sample on a second device on the same nanofluidic chip at a second time point.

Item 49. The method of item 48, wherein the difference between the time points is at least 4 hours, 6 hours, 12 hours, 14 hours, 24 hours, 2 days, 3 days, 4 days, 5 days, 6 days, or 7 days, 2 weeks, 1 month, 3 months, 6 months, 9 months, 1 year, 2 years, 3 years.

### EQUIVALENTS

The foregoing written specification is considered to be sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

As used herein, the term about refers to a numeric value, including, for example, whole numbers, fractions, and percentages, whether or not explicitly indicated. The term about generally refers to a range of numerical values (e.g., +/−5-10% of the recited range) that one of ordinary skill in the art would consider equivalent to the recited value (e.g., having the same function or result). When terms such as at least and about precede a list of numerical values or ranges, the terms modify all of the values or ranges provided in the list. In some instances, the term about may include numerical values that are rounded to the nearest significant figure.

What is claimed is:

1. A nanofluidic chip configured for high-volume manufacturing and maintaining sample integrity in multiplexed devices comprising:
a. at least two devices, wherein each device comprises
i. at least one sample inlet and
ii. at least one nanochannel; and
b. a detection region,
wherein the at least two devices pass through the detection region and
wherein the at least two devices are fluidically distinct from the inlet through the detection region, and
wherein actuation energy can be applied independently to at least two devices.

2. The nanofluidic chip of claim 1, wherein the chip comprises at least 3 devices.

3. The nanofluidic chip of claim 1, wherein each device comprises 1, 2, 3, 4, 5, 6, 7, 8, 10, 16, 20, 30, 50, 70, 100, 200, 300, 400, 500, 600, 700, 800, 900, 1000, 1200, 2400, 4800, or 5000 nanochannels.

4. The nanofluidic chip of claim 1, wherein the nanofluidic chip comprises a total of 2, 4, 6, 8, 12, 14, 16, 18, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 100, 150, 200, 250, 500, 1000, 5000, or 10,000 nanochannels that pass through the detection region.

5. The nanofluidic chip of claim 1, wherein each chip comprises 16 devices with 4 nanochannels each.

6. The nanofluidic chip of claim 1, wherein multiple nanofluidic chips can be assembled in a frame.

7. The nanofluidic chip of claim 1, wherein the detection region is configured to allow detection across multiple devices simultaneously.

8. The nanofluidic chip of claim 1, wherein the detection region is observable within a single field of view of a microscope objective.

9. The nanofluidic chip of claim 8, wherein the microscope objective is a 5×, 10×, 20×, 40×, 50×, 60× or 100× objective.

10. The nanofluidic chip of claim 1, wherein the actuation energy comprises current, voltage, hydrostatic pressure, pneumatic pressure, vacuum, flow focusing, or centrifugal force.

11. The nanofluidic chip of claim 1, wherein at least two devices allow for an applied voltage, applied hydrostatic pressure, applied pneumatic pressure, applied vacuum, applied flow focusing, or applied centrifugal force difference between devices.

12. The nanofluidic chip of claim 1, wherein the at least two devices allow for an applied voltage difference between devices.

13. The nanofluidic chip of claim 1, wherein the fluidically distinct inlets allow for an applied current difference between devices.

14. The nanofluidic chip of claim 1, wherein the detection region has an area of from 400 μm² to 25 mm².

15. The nanofluidic chip of claim 1, wherein all inlet microfluidics have the same length and/or all outlet microfluidics have the same length.

16. The nanofluidic chip of claim 1, wherein the nanochannel walls have a tapered profile constituting a draft angle.

17. The nanofluidic chip of claim 1, wherein the detection region is thinner than the other portions of the nanofluidic chip.

18. A method of producing the nanofluidic chip of claim 1, comprising producing a plastic nanofluidic chip using injection molding and fabricating the nanochannels with one or more nanofabrication techniques chosen from etching, photolithography, x-ray lithography, electron beam lithography, dip pen lithography, micromolding in capillaries (MIMIC), microtransfer molding, laser etching, high precision milling, electron discharge machining (EDM), focused ion beam (FIB) milling, nanolithography, and nanoimprint lithography.

19. The method of producing a nanofluidic chip according to claim 18, wherein the method results in nanochannel walls having a tapered profile constituting a draft angle.

20. The method of producing a nanofluidic chip according to claim 19, wherein the draft angle is 0.5, 1, 1.5, 2, 2.5, 3, 3.5, 4, 4.5, 5, 5.5, 6, 6.5, 7, 7.5, 8, 10, 15, 20, 25, 30, 35, 40, or 45 degrees.

21. A method of analyzing at least one biological sample in fluid form on the nanofluidic chip of claim 1, comprising loading a biological sample onto one or more devices using a sample inlet, flowing the biological sample through the nanochannel, and conducting a detection step.

22. The method of claim 21, wherein the method comprises analyzing at least one biological sample on a first device at a first time point and analyzing at least one biological sample on a second device on the same nanofluidic chip at a second time point.

23. The method of claim 22, wherein the difference between the time points is at least 4 hours.
